(19) United States
(12) Patent Application Publication
(10) Pub. No.: US 2021/0017813 A1
(43) Pub. Date: Jan. 21, 2021

(54) COMBINATION HORIZONTAL BLIND LADDER AND OPERATING CABLE

(71) Applicant: 3 Day Blinds LLC, Irvine, CA (US)

(72) Inventor: Michael J. McCarty, Irvine, CA (US)

(21) Appl. No.: 16/517,233

(22) Filed: Jul. 19, 2019

(51) Int. Cl. E06B 9/326; E06B 9/322; E06B 9/304

(52) U.S. Cl. CPC E06B 9/326; E06B 2009/285; E06B 9/304; E06B 9/322

(57) ABSTRACT

A horizontal blind system includes a plurality of elongate members and a plurality of support rungs. Each support rung extends along an end region of a respective one of the plurality of elongate members. A pair of outer sleeves extend between adjacent ones of the plurality of support rungs, with each outer sleeve defining an inner opening extending along a length thereof. A pair of lift cables extend through a respective inner openings of the pair of outer sleeves such that a majority of each lift cable is concealed by a respective outer sleeve. The pair of lift cables are moveable relative to the pair of outer sleeves between a stowed configuration and a deployed configuration, with a distance between at least one adjacent pair of the plurality of support rungs decreasing as the pair of lift cables transition from the deployed configuration toward the stowed configuration.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a horizontal blind system and more specifically to a horizontal blind system including at least one lift cable concealed within a ladder cable to mitigate a choking hazard associated with the lift cable.

### 2. Description of the Related Art

Window treatments, such as blinds, shutters, shades, curtains, drapes, etc., are commonly placed over windows to allow a user to selectively cover and uncover the window. It may be desirable to leave the window uncovered during the day to allow natural light to pass through the window to illuminate a room. However, on certain occasions, such as at night or during hot days, it may be desirable to cover the window for privacy or to provide shade. For instance, covering the window may allow a user to darken a room when desired (e.g., to remove sunlight glare from a television) or to keep hot sunlight from entering the room during a hot day. Thus, the ability to selectively cover and uncover the windows is highly desirable.

Of all the various types of window treatments that are available, horizontal blinds have found widespread appeal. Horizontal blinds typically include a plurality of slats supported by a ladder cable. The ladder cable may support each individual slat and allow for selective tilting of the slats to control the amount of light that passes through the blinds. A lift cable may be used to selectively raise or lower the bottom of the blinds to vary the extent to which the blinds extend over the window.

Although horizontal blinds may provide desirable benefits, in addition to enhancing the overall interior aesthetics of an interior space, there are certain drawbacks associated with conventional horizontal blinds. One particular drawback is that the lift cable may be exposed, which may create a safety hazard. In particular, small children may be able to access the horizontal blinds, particularly when standing on a sofa or chair, and grab at the horizontal blinds in a playful manner. Oftentimes, the child may grab and pull on the lift cable and become entangled in the lift cable. If the child were to sit down or fall from their standing position on the sofa or chair, the lift cable may create a strangulation concern.

Accordingly, there is a need in the art for an improved horizontal blind system which mitigates safety issues associated with an exposed lift cable. Various aspects of the present disclosure address this particular need, as will be discussed in more detail below.

### BRIEF SUMMARY

In accordance with one embodiment of the present disclosure, there is provided a horizontal blind system that includes concealed lift cables. By concealing the lift cables, access to the lift cables is restricted and thus, a choking hazard associated with the lift cables is mitigated. Therefore, the horizontal blind system may be a much safer alternative to conventional horizontal blind systems which typically include exposed lift cables.

According to one embodiment, there is provided a horizontal blind system comprising an upper support and a pair of hollow ladder cables extending from the upper support along a longitudinal axis. A pair of lift cables extend from the upper support within respective ones of the pair of hollow ladder cables such that the pair of lift cables are substantially concealed by the pair of hollow ladder cables. The pair of lift cables include respective end portions, with a distance between the end portions and the upper support defining a deployed length of the horizontal blind system. The horizontal blind system additionally includes a plurality of ladder rung elements extending between the pair of hollow ladder cables. A plurality of elongate members are positioned between the pair of hollow ladder cables and between the pair of lift cables, each elongate member having an end portion supported by a respective one of the plurality of ladder rung elements. A tilt controller is in operative communication with the pair of hollow ladder cables and is configured to move the pair of hollow ladder cables in opposite directions parallel to the longitudinal axis to control a tilt angle of the plurality of ladder rung elements extending between the pair of hollow ladder cables. A lift controller is in operative communication with the pair of lift cables to move the lift cables along the longitudinal axis to control the deployed length of the horizontal blind system.

Each hollow ladder cable may define an inner diameter that is between 0.8 mm and 2.0 mm, and more specifically, the inner diameter of each hollow ladder cable may be 1.2 mm. Each of the hollow ladder cables may be formed from a woven material.

Each lift cable may define an outer diameter that is between 0.5 mm and 1.7 mm, and more specifically, the outer diameter of each lift cable may be 0.9 mm.

The horizontal blind system may additionally include a lower support coupled to the end portions of the pair of lift cables.

According to another embodiment, there is provided a horizontal blind system including a plurality of elongate members and a plurality of support rungs. Each support rung extends along an end region of a respective one of the plurality of elongate members. A pair of outer sleeves extend between adjacent ones of the plurality of support rungs, with each outer sleeve defining an inner opening extending along a length thereof. A pair of lift cables extend through a respective inner openings of the pair of outer sleeves such that a majority of each lift cable is concealed by a respective outer sleeve. The pair of lift cables are moveable relative to the pair of outer sleeves between a stowed configuration and a deployed configuration, with a distance between at least one adjacent pair of the plurality of support rungs decreasing as the pair of lift cables transition from the deployed configuration toward the stowed configuration.

According to yet another embodiment, there is provided a method of assembling a horizontal blind system. The method includes advancing a pair of lift cables through respective ones of a pair of outer sleeves such that a majority of each lift cable is concealed by a respective outer sleeve. The method additionally includes connecting a plurality of support rungs to the pair of outer sleeves, such that each support rung is attached to both of the pair of outer sleeves and extends therebetween. The method further comprises placing a plurality of elongate members over respective ones of the plurality of support rungs.

The method may further comprising the step of connecting a tilt controller in operative communication with the pair of outer sleeves, with the tilt controller being configured to move the pair of outer sleeves in opposite directions to control a tilt angle of the plurality of support rungs.

The method may additionally include the step of connecting a lift controller in operative communication with the pair of lift cables, with the lift controller being configured to move the lift cables relative to the pair of outer sleeves.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a front view of a prior art horizontal blind system including exposed lift cables;

FIG. 2 is a side sectional view of the prior art horizontal blind system of FIG. 1;

FIG. 3 is a side sectional view of another embodiment of a prior art horizontal blind system including exposed lift cables;

FIG. 4 is a front view of a horizontal bind system including concealed lift cables, in accordance with one embodiment of the present disclosure;

FIG. 5 is a partial side sectional view of a control cable assembly including concealed lift cables, the horizontal blind system being in a deployed configuration;

FIG. 6 is a partial side sectional view of the horizontal blind system in a stowed configuration; and

FIG. 7 is a partial cross sectional view of the horizontal blind system depicted in FIG. 4, depicting a lift cable concealed in a hollow ladder cable.

Common reference numerals are used throughout the drawings and the detailed description to indicate the same elements.

### DETAILED DESCRIPTION

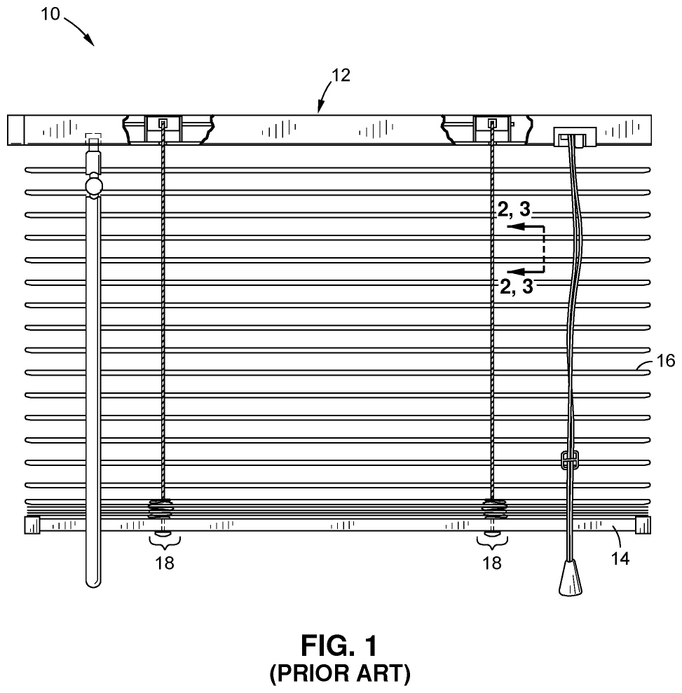

Referring first to FIG. 1, there is depicted a front view of a prior art horizontal blind system 10 that may be positioned over a window (not shown) to provide shade or coverage over the window. The prior art horizontal blind system 10 generally includes an upper support 12, a lower support 14, and a plurality of slats (e.g., elongate members) 16 positioned between the upper support 12 and the lower support 14. Each of the slats 16 may extend longitudinally in a generally horizontal direction, with the plurality of slats 16 arranged relative to each other in a generally vertical stack.

The deployed length of the horizontal blind system 10 system and the tilt of the slats 16 may be varied to achieve a desired operative length of the system 10 and a desired amount of shade provided by the horizontal blind system 10. To that end, the prior art horizontal blind system 10 may include a pair of control cable assemblies 18 extending between the upper support 12 and the lower support 14 to control both the position of the lower support 14 relative to the upper support 12, as well as the tilt of the slats 16. The position of the lower support 14 may be varied relative to the upper support 12 between a deployed position and a stowed position to selectively vary the amount of coverage provided by the horizontal blind system 10. The horizontal blind system 10 shown in FIG. 1 is in a partially deployed position, as the lower support 12 may be moved further away from the upper support 14. Movement of the lower support 14 relative to the upper support 12 may cause the spacing between adjacent slats 16 to be varied to modify the operative length of the horizontal blind system 10. The space between adjacent slats 16 may be increased to increase the operative length of the horizontal blind system 10, and conversely, the space between adjacent slats 16 may be decreased to decrease the operative length of the horizontal blind system 10.

In addition to allowing variability between the deployed and stowed positions, the horizontal blind system 10 may additionally allow for variability in a tilt angle of the slats 16. In particular, the orientation of the slats 16 may be varied between a substantially horizontal position (e.g., an open position) and a substantially vertical position (e.g., a closed position). When the slats 16 are in the horizontal position, more light may pass through the horizontal blind system 10, and when the slats 16 are in the vertical position, more light is blocked from passing through the horizontal blind system 10.

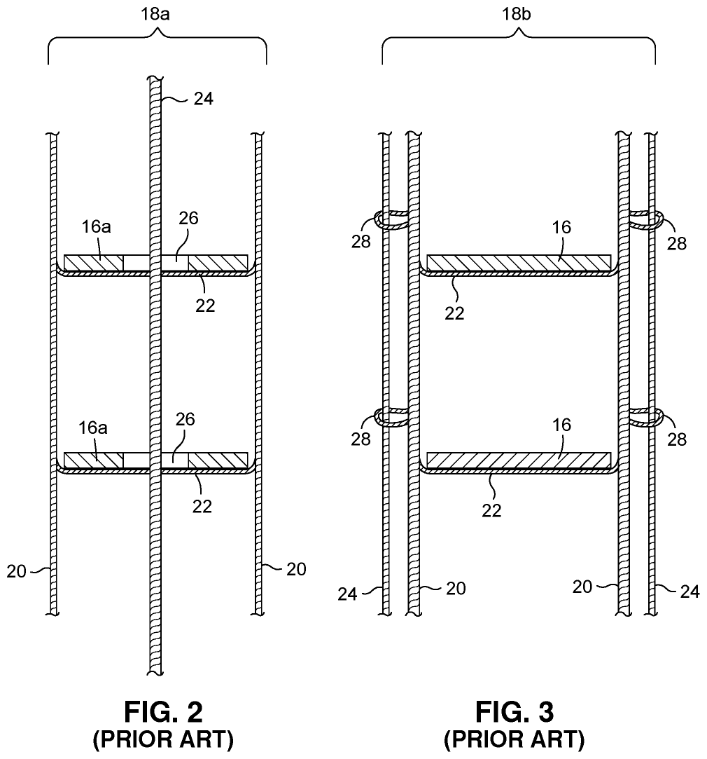

Referring to FIG. 2, one embodiment of each control cable assembly 18a includes a pair of ladder cables 20, a ladder rung element 22, and a lift cable 24, with each ladder rung element 22 extending between the pair of ladder cables 20. Each of the slats 16a may include a pair of slots or openings 26 for accommodating the lift cables 24. The lift cables 24 may extend generally between the pair of ladder cables 20, generally at a midpoint of the depth of the vertical blind system 10. The lift cables 24 are exposed and not concealed, and thus, can be grabbed, such as by a curious child. If the lift cable 24 is grabbed, the child may become entangled in the lift cable 24 and risk strangulation.

FIG. 3 is a partial side sectional view of another embodiment of a prior art control cable assembly 18b including a pair of exposed lift cables 24. In particular, instead of the lift cable 24 extending between the ladder cables 20 and through the 26, as shown in FIG. 2, the lift cables 24 may extend on the outside of the ladder cables 20 and the slats 16. The control cable assembly 18b may include a plurality of guide loops 28 extending from each ladder cable 20. Each lift cable 24 may extend through the guide loops 28 attached to a common ladder cable 20.

In both embodiments depicted in FIGS. 1-3, the lift cables 24 are exposed, and thus, are at risk of becoming entangled on a small child, which may create a choking or strangulation hazard.

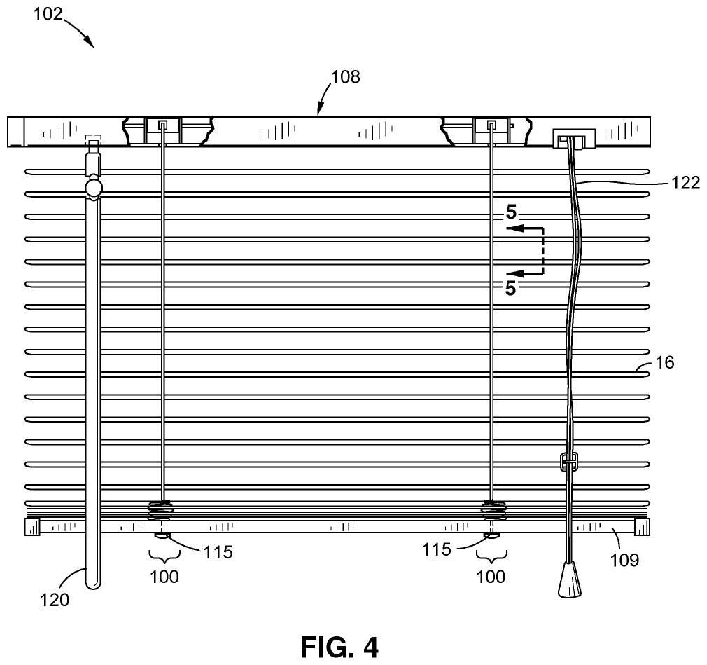

FIGS. 4-6 depict an embodiment of a control cable assembly 100 for a horizontal blind system 102, with the control cable assembly 100 being specifically configured and adapted to mitigate the choking or strangulation hazard associated therewith. In general, the choking or strangulation hazard may be mitigated by concealing a lift cable 104, thereby reducing the accessibility to the lift cable 104 to curious children.

According to one embodiment, the horizontal blind system 102 includes a pair of control cable assemblies 100, with each control cable assembly 100 including a pair of hollow ladder cables (e.g., outer sleeves) 106 positioned between an upper support 108 and a lower support 109. The hollow ladder cables 106 may extend downwardly from the upper support 108 along a longitudinal axis 110, which may be generally perpendicular to the length of the upper support 108. In the exemplary embodiment depicted in FIG. 4, the horizontal blind system 102 includes four hollow ladder cables 106, and more specifically, two hollow ladder cables 106 in each control cable assembly 100.

Each hollow ladder cable 106 may include an inner wall 111 (see FIG. 7) defining an inner opening 112 extending along a length thereof. The inner wall 111 may define an inner diameter, ID, that is between 0.8 mm and 2.0 mm, and more specifically, the inner diameter ID of each hollow ladder cable 106 may be 1.2 mm. Each of the hollow ladder cables 106 may be formed from a woven material or another collapsible material, which may allow the hollow ladder cable 106 to fold or collapse as the horizontal blind system 102 is transitioned between a stowed configuration and a deployed configuration, as will be described in more detail below.

Each control cable assembly 100 may additionally include a plurality of ladder rung elements (e.g., a plurality of support rungs) 114 extending between the pair of hollow ladder cables 106. The ladder rung elements 114 in a given control cable assembly 100 extend from respective locations on the hollow ladder cable 106 which are spaced from each other along the longitudinal axis 110. In this regard, the pair of hollow ladder cables 106 and the plurality of ladder rung elements 114 may define a configuration that is similar to a conventional ladder. Each ladder rung elements 114 may include a string or other flexible members that extend between the hollow ladder cables 106 in a given control cable assembly 100. The ladder rung elements 114 are configured to support an end portion of a given slat 118, and facilitate tilting of the slat 118, as will be described in more detail below.

Each control cable assembly 100 may further include a pair of lift cables 104 extending between the upper support 108 and the lower support 109 within respective ones of the pair of hollow ladder cables 106. By routing the lift cables 104 through respective ladder cables 106, the pair of lift cables 104 may be substantially concealed by the pair of hollow ladder cables 106. In this regard, it is contemplated that in certain embodiments, the lift cables 104 may be entirely concealed by the ladder cables 106, while in other embodiments, the hollow ladder cables 106 may include slits or other small openings, in which case the lift cables 104 are not entirely concealed; however, the slits or openings may be small enough to prevent the lift cables 104 from passing therethrough.

The pair of lift cables 104 extend through the inner opening 112 the corresponding hollow ladder cables 106 such that a majority of each lift cable 104 is concealed by a respective ladder cable 106. Each lift cable 104 may define an outer diameter, OD, that is between 0.5 mm and 1.7 mm, and more specifically, the outer diameter OD of each lift cable 104 may be 0.9 mm. In this regard, the outer diameter OD of the lift cable 104 may be less than the inner diameter ID of the respective ladder cable 106 to define an annular gap 116 between the lift cable 104 and the ladder cable 106.

Each lift cable 104 extends from the upper support 108 and terminates at a distal end portion 115, which may be secured to the lower support 109. In this regard, it is contemplated that an upper portion of the lift cables 104 may extend out of the hollow ladder cables 106 and into the upper support 108, while a lower portion of the lift cables 104 may extend out of the hollow ladder cables 106 and into or onto the lower support 109. The distance between the distal end portions 115 and the upper support 108 along the longitudinal axis 110 may define a deployed length of the horizontal blind system 102. It is contemplated that the deployed length may also be defined as the distance between the upper support 108 and the lower support 109.

The horizontal blind system 102 may additionally include a plurality of slats 118 (e.g., elongate members). Each slat 118 may extend between the pair of control cable assemblies 100, such that each slat 118 is supported by a ladder rung element 114 on one end portion thereof and another ladder rung element 114 on another end portion thereof. In this regard, each ladder rung element 114 may extend under and along an end region of a respective slat 118. The distance between adjacent slats 118 may be varied as the horizontal blind system 102 is transitioned between the deployed configuration and the stowed configuration.

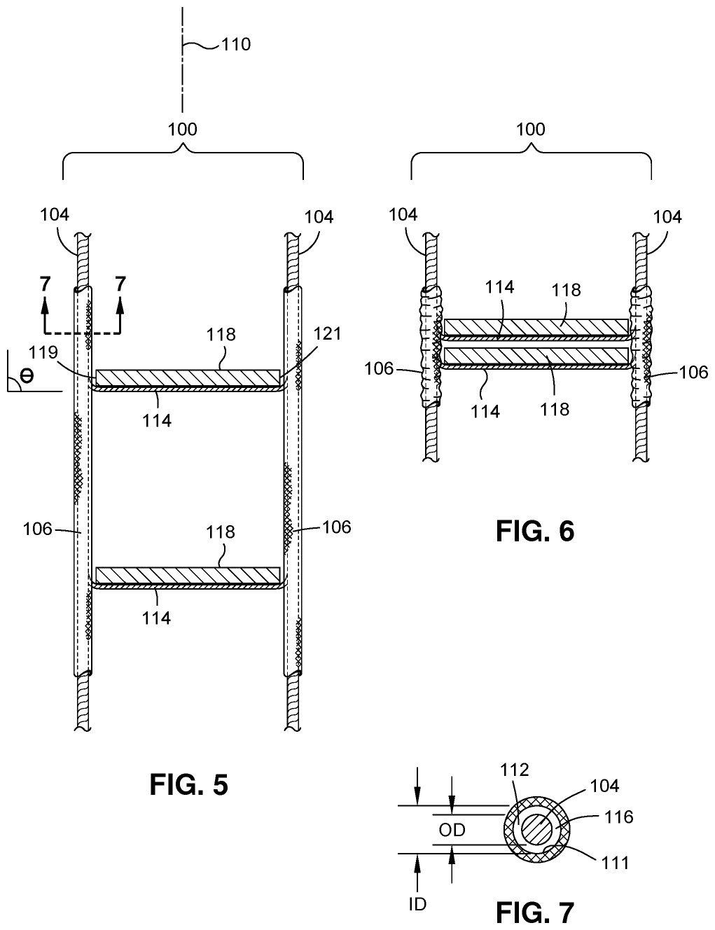

Each slat 118 may include a forward face 119 and a rearward face 121 to define a slat width therebetween. The slat width may be smaller than the distance between the pair of hollow ladder cables 106 in the corresponding control cable assembly 100 to allow each slat 118 to be positioned between the pair of hollow ladder cables 106 and between the pair of lift cables 104, as can be seen in FIGS. 5 and 6.

A tilt controller 120 may be in operative communication with the pair of hollow ladder cables 106 and may be configured to move the pair of hollow ladder cables 106 in opposite directions parallel to the longitudinal axis 110 to control a tilt angle, Θ, of the plurality of ladder rung elements 114 extending between the pair of hollow ladder cables 106. The tilt angle Θ may be defined as the angle between the longitudinal axis 110 and the ladder rung elements 114. In this regard, since each ladder rung element 114 is attached to the hollow ladder cables 106 of a given control cable assembly 100, and since the tilt controller 120 may move the hollow ladder cables 106 in opposite directions (e.g., one up and the other down, or vice versa), the angle of the ladder rung element 114 may be varied. As shown in FIG. 5, the tilt angle is approximately 90 degrees, which is associated with the slat 118 being in a generally horizontal configuration. As the tilt angle Θ approaches zero, the slat 118 may be angled into a generally vertical configuration. According to one embodiment, the tilt controller 120 includes a wand that is rotatably coupled to a shaft positioned in the upper support 108. The wand is coupled to the shaft, such that as the wand is rotated by a user in a first direction, the rod rotates in a first direction to raise one hollow ladder cable 106 and lower another hollow ladder cable 106. Conversely, when the want is rotated by the user in a second direction, the rod rotates in a second direction to move the ladder cables 106 in opposite directions. The interconnection between the wand and the rod may be via a worm drive (e.g., a worm screw and a worm gear), or other mechanical engagements known in the art.

A lift controller 122 may be in operative communication with the pair of lift cables 104 to move the lift cables 104 along the longitudinal axis 110 to control the deployed length of the horizontal blind system 102. In particular, the lift controller 122 may include a portion of each lift cable 104 and by either pulling or releasing the lift controller 122, a user may selectively transition the horizontal blind system 102 between a stowed configuration and a deployed configuration. In this regard, to transition the horizontal blind system 102 toward the stowed configuration, a user may pull on the lift controller 122, thereby increasing the length thereof, which in turn, shortens the length of the lift cables 104 connecting the lower support rod 109 to the upper support rod 108, and thus, moves the lower support rod 109 toward the upper support rod 108. As the horizontal blind system 102 is transitioned toward the stowed configuration, the hollow ladder cables 106 may collapse or fold to assume a more compact configuration. Furthermore, as the horizontal blind system 102 transitions from the deployed configuration toward the stowed configuration, the ladder rung elements 114 are moved toward the upwardly adjacent ladder rung element 114 one at a time, starting with the bottommost ladder rung element 114. To transition the horizontal blind system 102 toward the deployed position, the user may release the lift controller 122 to decrease the length thereof, which in turn increases the length of the lift cables 104 connecting the lower support rod 109 to the upper support rod 108, and thus, moves the lower support rod 109 away from the upper support rod 108. As the horizontal blind system 102 is transitioned toward the deployed configuration, the hollow ladder cables 106 may extend or unfold to assume an extended configuration. Along these lines, the tension in the hollow ladder cables 106 may increase as the horizontal blind system 102 is transitioned toward the deployed configuration. Furthermore, as the horizontal blind system 102 transitions from the stowed configuration toward the deployed, the ladder rung elements 114 are moved away from the upwardly adjacent ladder rung element 114 one at a time, starting with the uppermost ladder rung element 114.

As the user pulls or releases the lift controller 122, the lift cables 104 may move within and relative to their respective hollow ladder cables 106. In other words, as the lift cables 104 move, the hollow ladder cables 106 may remain substantially stationary. Furthermore, as the lift cables 104 move, the lift cables 104 may remain safely concealed by the hollow ladder cables 106 to restrict access to the lift cables 106. In this regard, the hollow ladder cables 106 may function as a protective sheath to the lift cables 104 to safely conceal the lift cables.

As the user twists the tilt controller 120, the hollow ladder cables 106 of each control cable assembly 100 move in opposite directions, which in turn, results in movement of the ladder rung element 114 to adjust the tilt angle Θ. As the hollow ladder cables 106 are moved due to rotation of the tilt controller 120, the lift cables 104 may remain substantially stationary.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A horizontal blind system comprising:
an upper support;
a pair of hollow ladder cables extending from the upper support along a longitudinal axis;
a pair of lift cables extending from the upper support within respective ones of the pair of hollow ladder cables, such that the pair of lift cables are substantially concealed by the pair of hollow ladder cables, the pair of lift cables having respective end portions, a distance between the end portions and the upper support defining a deployed length of the horizontal blind system;
a plurality of ladder rung elements extending between the pair of hollow ladder cables;
a plurality of elongate members positioned between the pair of hollow ladder cables and between the pair of lift cables, each elongate member having an end portion supported by a respective one of the plurality of ladder rung elements;
a tilt controller in operative communication with the pair of hollow ladder cables and configured to move the pair of hollow ladder cables in opposite directions parallel to the longitudinal axis to control a tilt angle of the plurality of ladder rung elements extending between the pair of hollow ladder cables; and
a lift controller in operative communication with the pair of lift cables to move the lift cables along the longitudinal axis to control the deployed length of the horizontal blind system.

2. The horizontal blind system recited in claim 1, wherein each hollow ladder cable defines an inner diameter that is between 0.8 mm and 2.0 mm.

3. The horizontal blind system recited in claim 2, wherein the inner diameter of each hollow ladder cable is 1.2 mm.

4. The horizontal blind system recited in claim 2, wherein each lift cable defines an outer diameter that is between 0.5 mm and 1.7 mm.

5. The horizontal blind system recited in claim 4, wherein the outer diameter of each lift cable is 0.9 mm.

6. The horizontal blind system recited in claim 1, further comprising a lower support coupled to the end portions of the pair of lift cables.

7. The horizontal blind system recited in claim 1, wherein each of the hollow ladder cables is formed from a woven material.

8. A horizontal blind system comprising:
a plurality of elongate members;
a plurality of support rungs, each support rung extending along an end region of a respective one of the plurality of elongate members;
a pair of outer sleeves extending between adjacent ones of the plurality of support rungs, each outer sleeve defining an inner opening extending along a length thereof; and
a pair of lift cables extending through a respective inner openings of the pair of outer sleeves such that a majority of each lift cable is concealed by a respective outer sleeve, the pair of lift cables being moveable relative to the pair of outer sleeves between a stowed configuration and a deployed configuration, a distance between at least one adjacent pair of the plurality of support rungs decreasing as the pair of lift cables transition from the deployed configuraiton toward the stowed configuration.

9. The horizontal blind system recited in claim 8, wherein each outer sleeve defines an inner diameter that is between 0.8 mm and 2.0 mm.

10. The horizontal blind system recited in claim 9, wherein the inner diameter of each outer sleeve is 1.2 mm.

11. The horizontal blind system recited in claim 9, wherein each lift cable defines an outer diameter that is between 0.5 mm and 1.7 mm.

12. The horizontal blind system recited in claim 11, wherein the outer diameter of each lift cable is 0.9 mm.

13. The horizontal blind system recited in claim 8, wherein each of the outer sleeves is formed from a woven material.

14. The horizontal blind system recited in claim 8, further comprising a tilt controller in operative communication with the pair of outer sleeves and configured to move the pair of outer sleeves in opposite directions to control a tilt angle of the plurality of support rungs.

15. The horizontal blind system recited in claim 8, further comprising a lift controller in operative communication with the pair of lift cables to move the lift cables between the deployed configuration and the stowed configuration.

16. A method of assembling a horizontal blind system:
advancing a pair of lift cables through respective ones of a pair of outer sleeves, such that a majority of each lift cable is concealed by a respective outer sleeve;
connecting a plurality of support rungs to the pair of outer sleeves, such that each support rung is attached to both of the pair of outer sleeves and extends therebetween; and
placing a plurality of elongate members over respective ones of the plurality of support rungs.

17. The method recited in claim 16, further comprising the step of connecting a tilt controller in operative communication with the pair of outer sleeves, the tilt controller being configured to move the pair of outer sleeves in opposite directions to control a tilt angle of the plurality of support rungs.

18. The method recited in claim 16, further comprising the step of connecting a lift controller in operative communication with the pair of lift cables, the lift controller being configured to move the lift cables relative to the pair of outer sleeves.

19. The method recited in claim 16, wherein each outer sleeve used in the advancing step defines an inner diameter that is between 0.8 mm and 2.0 mm.

20. The method recited in claim 17, wherein each lift cable used in the advancing step defines an outer diameter that is between 0.5 mm and 1.7 mm.
